(19) United States
(12) Patent Application Publication
(10) Pub. No.: US 2021/0298271 A1
(43) Pub. Date: Sep. 30, 2021

(54) ANIMAL FLOATATION DEVICE

(71) Applicant: David L. Izatt, Palm Springs, CA (US)

(72) Inventor: David L. Izatt, Palm Springs, CA (US)

(21) Appl. No.: 16/835,002

(22) Filed: Mar. 30, 2020

(51) Int. Cl. A01K 29/00

(52) U.S. Cl. CPC A01K 29/00

(57) ABSTRACT

A housing for use in a floatation device comprises first and second rectangular portions each having four sides. Three sides of the first rectangular portion are coupled to three sides of the second rectangular portion, and a fastener such as a zipper is coupled to the fourth sides of the first and second rectangular portions. The housing may be made of materials having high strength and resiliency such that they are not easily torn, popped, punctured, rent, or otherwise damaged by claws over the course of repeated use, such as by a dog. The fastener may be opened or closed to allow or block access to an internal cavity within the housing. The internal cavity is configured to accommodate a plurality of pool noodles that provide the housing and the floatation device with buoyancy and with a continuous buoyant floor on which a person, dog, or other animal can be supported within a body of water. The housing may include a plurality of dividers that divide the internal cavity into a plurality of internal sub-cavities.

### BACKGROUND

### Technical Field

The present disclosure relates generally to rafts or floatation devices, and more particularly to devices that allow pets such as dogs to float at the surface of bodies of water such as lakes or pools.

### Description of the Related Art

A variety of different types of floatation devices are currently available in the marketplace. Many floatation devices are designed to allow a human to sit or lay comfortably in or on a body of water, such as a river, a lake, or a pool. Other floatation devices are designed specifically to allow pets or other animals, such as dogs, to sit or lay comfortably in or on a body of water. Existing floatation devices that are designed for dogs have various drawbacks. As one example, such devices may be relatively bulky and inconvenient to travel with. Furthermore, one particular difficulty of existing products is in allowing dogs of all sizes to easily climb up onto, or climb off of, the floatation device. In particular, some existing products include buoyant components, especially at the peripheries thereof, that cause the edges of the floatation devices to sit relatively high in the water, thereby forming a wall impeding the ability of dogs to swim up to, and climb onto, the device. Additionally, many existing products are relatively fragile and tend to be torn, popped, punctured, rent, or otherwise damaged by claws over the course of repeated use, such as by a dog.

### BRIEF SUMMARY

A housing for use in a floatation device, the housing having substantially no buoyancy in water, may be summarized as comprising: a rectangular upper portion having a first side, a second side, a third side, and a fourth side; a rectangular lower portion having a first side, a second side, a third side, and a fourth side, wherein the first side of the rectangular lower portion is coupled to the first side of the rectangular upper portion, the second side of the rectangular lower portion is coupled to the second side of the rectangular upper portion, and the third side of the rectangular lower portion is coupled to the third side of the rectangular upper portion; and a fastener configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion; wherein the internal cavity is configured to be filled with pool noodles such that the pool noodles collectively extend across substantially an entire length of the housing and across substantially an entire width of the housing.

The internal cavity may be configured to be filled with pool noodles such that the pool noodles collectively extend across an entire length of the housing and across an entire width of the housing. The rectangular upper portion may be made of a single sheet of fabric. The rectangular lower portion may be made of a single sheet of fabric. The housing may further comprise a first divider coupled to an internal surface of the rectangular upper portion and coupled to an internal surface of the rectangular lower portion such that the first divider has a first end proximate the fourth side of the rectangular upper portion and proximate the fourth side of the rectangular lower portion. The housing may further comprise a second divider coupled to an internal surface of the rectangular upper portion and coupled to an internal surface of the rectangular lower portion such that the second divider has a first end proximate the fourth side of the rectangular upper portion and proximate the fourth side of the rectangular lower portion. The second divider may be parallel to the first divider. The housing may further comprise a third divider coupled to an internal surface of the rectangular upper portion and coupled to an internal surface of the rectangular lower portion such that the third divider has a first end proximate the fourth side of the rectangular upper portion and proximate the fourth side of the rectangular lower portion. The third divider may be parallel to the first and second dividers. The housing may be configured to be folded up into a compact configuration for storage and transport.

A flotation device may be summarized as comprising: a housing including: a rectangular upper portion having a first side, a second side, a third side, and a fourth side; a rectangular lower portion having a first side, a second side, a third side, and a fourth side, wherein the first side of the rectangular lower portion is coupled to the first side of the rectangular upper portion, the second side of the rectangular lower portion is coupled to the second side of the rectangular upper portion, and the third side of the rectangular lower portion is coupled to the third side of the rectangular upper portion; and a fastener configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion; wherein the internal cavity is configured to be filled with pool noodles such that the pool noodles collectively extend across substantially an entire length of the housing and across substantially an entire width of the housing; and a plurality of pool noodles located inside the internal cavity, wherein the pool noodles collectively extend across substantially an entire length of the housing and across substantially an entire width of the housing.

The pool noodles may collectively extend across an entire length of the housing and across an entire width of the housing. The floatation device may further comprise a first divider coupled to an internal surface of the rectangular upper portion and coupled to an internal surface of the rectangular lower portion such that the first divider has a first end proximate the fourth side of the rectangular upper portion and proximate the fourth side of the rectangular lower portion, wherein two pool noodles of the plurality of pool noodles are located between the first divider and the first sides of the rectangular upper and lower portions. The floatation device may further comprise a second divider coupled to an internal surface of the rectangular upper portion and coupled to an internal surface of the rectangular lower portion such that the second divider has a first end proximate the fourth side of the rectangular upper portion and proximate the fourth side of the rectangular lower portion, wherein two pool noodles of the plurality of pool noodles are located between the first divider and the second divider. The floatation device may further comprise a third divider coupled to an internal surface of the rectangular upper portion and coupled to an internal surface of the rectangular lower portion such that the third divider has a first end proximate the fourth side of the rectangular upper portion and proximate the fourth side of the rectangular lower portion, wherein two pool noodles of the plurality of pool noodles are located between the second divider and the third divider and two pool noodles of the plurality of pool noodles are located between the third divider and the third sides of the rectangular upper and lower portions.

A method of manufacturing a housing for use in a floatation device may be summarized as comprising: obtaining a first rectangular sheet of material having a first side, a second side, a third side, and a fourth side; obtaining a second rectangular sheet of material having a first side, a second side, a third side, and a fourth side; stitching the first side of the rectangular lower portion to the first side of the rectangular upper portion, the second side of the rectangular lower portion to the second side of the rectangular upper portion, and the third side of the rectangular lower portion to the third side of the rectangular upper portion; and stitching a zipper to the fourth side of the rectangular upper portion and to the fourth side of the rectangular lower portion such that the zipper is configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion; wherein the internal cavity is configured to be filled with pool noodles such that the pool noodles collectively extend across substantially an entire length of the housing and across substantially an entire width of the housing.

The method may further comprise: stitching a first divider to an internal surface of the rectangular upper portion and to an internal surface of the rectangular lower portion such that the first divider has a first end proximate the fourth side of the rectangular upper portion and proximate the fourth side of the rectangular lower portion. The method may further comprise: stitching a second divider to an internal surface of the rectangular upper portion and to an internal surface of the rectangular lower portion such that the second divider has a first end proximate the fourth side of the rectangular upper portion and proximate the fourth side of the rectangular lower portion. The method may further comprise: stitching a third divider to an internal surface of the rectangular upper portion and to an internal surface of the rectangular lower portion such that the third divider has a first end proximate the fourth side of the rectangular upper portion and proximate the fourth side of the rectangular lower portion. The first, second, and third dividers may be parallel to one another along their entire lengths.

### BRIEF DESCRIPTION OF THE SEVERAL VIEWS OF THE DRAWINGS

FIG. 1 illustrates a perspective view of a housing of a floatation device in accordance with implementations of the present disclosure.

FIG. 2 illustrates another perspective view of the housing of FIG. 1, with a front end thereof open to reveal internal components thereof in accordance with implementations of the present disclosure.

FIG. 3 illustrates another perspective view of the housing of FIGS. 1 and 2 with a plurality of pool noodles positioned on top of the housing to illustrate scale of the housing in accordance with implementations of the present disclosure.

FIG. 4 illustrates a front end view of the housing of FIGS. 1 and 2 with a plurality of pool noodles positioned inside the housing in accordance with implementations of the present disclosure.

FIG. 5 illustrates a front end view of a portion of the housing with the plurality of pool noodles positioned therein, the portion of the housing including a zipper in an open position in accordance with implementations of the present disclosure.

FIG. 6 illustrates a front end view of another portion of the housing with the plurality of pool noodles positioned therein, the portion of the housing including a zipper in a closed position in accordance with implementations of the present disclosure.

FIG. 7 illustrates another perspective view of the housing of FIGS. 1 and 2 in a folded up, compact configuration, such as for storage of the housing, in accordance with implementations of the present disclosure.

FIG. 8 illustrates rear perspective view of the housing with a strap coupled thereto, such as for use as a handle.

### DETAILED DESCRIPTION

Persons of ordinary skill in the art will understand that the present disclosure is illustrative only and not in any way limiting. Other implementations and various combinations of the presently disclosed system and method readily suggest themselves to such skilled persons having the assistance of this disclosure.

This detailed description is intended to teach a person of skill in the art details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Throughout the specification, claims, and drawings, the following terms take the meaning explicitly associated herein, unless the context clearly dictates otherwise. The term “herein” refers to the specification, claims, and drawings associated with the current application. The phrases “in one implementation,” “in another implementation,” “in various implementations,” “in some implementations,” “in other implementations,” and other variations thereof refer to one or more features, structures, functions, limitations, or characteristics of the present disclosure, and are not limited to the same or different implementations unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Moreover, the various features of the representative examples and the dependent claims may be combined in ways that are not specifically and explicitly enumerated in order to provide additional useful implementations of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples. Additionally, the headings and Abstract provided herein are for convenience only and do not limit the scope or meaning of the implementations.

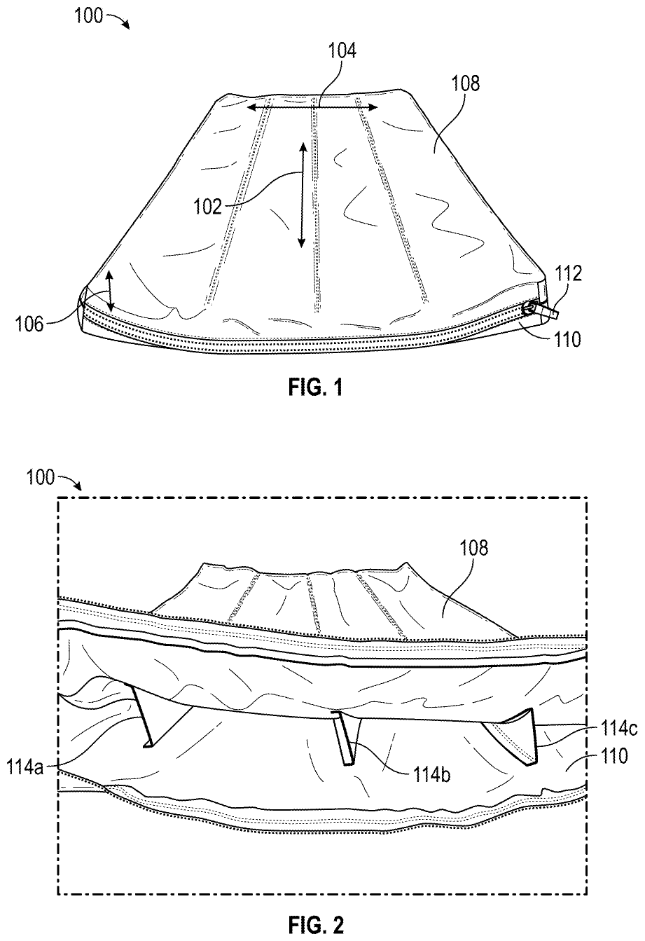

FIG. 1 illustrates a housing 100 for use in a raft or a floatation device. As illustrated in FIG. 1, the housing 100 has a generally rectangular shape when seen in a plan view, such that it has a first, long axis 102 that extends from a front of the housing 100 to a rear of the housing 100 opposite the front, a second, short axis 104 that extends from a first, left side of the housing 100 to a second, right side of the housng 100 opposite the left side, and a third, vertical axis 106 that extends from a top of the housing 100 to a bottom of the housing 100 opposite the top. In some implementations, the housing 100 has a length along the long axis 102 of at least 42 inches, 48 inches, or 50 inches, and/or less than 54 inches, 60 inches, or 66 inches, and/or about 52 inches. In some implementations, the housing 100 has a width along the short axis 104 of at least 20 inches or 24 inches, and/or less than 30 inches or 36 inches, and/or about 28 inches.

As used herein, terms of relative elevation, such as “top,” “bottom,” “above,” “below,” etc., carry their ordinary meaning with respect to a direction of gravity. As used herein, terms of relative location, such as “front” and “back” or “rear,” carry their ordinary meaning, where an opening of the housing 100 and a zipper configured to open and close the opening are at the front of the housing 100. As used herein, terms of relative location, such as “left” and “right” carry their ordinary meaning with respect to a viewer looking at the front of an object.

FIG. 1 further illustrates that the housing 100 includes a top or upper portion 108 and a bottom or lower portion 110. Each of the upper and lower portions 108, 110 is made of a single sheet or piece of material that extends in a generally horizontal plane across the long axis from the front of the housing 100 to the rear of the housing 100, and across the short axis from the left side of the housing 100 to the right side of the housing 100. In some implementations, the upper and lower portions 108, 110 are made from different materials. In other implementations, the upper and lower portions 108, 110 are made from the same material but have different colors. In other implementations, the upper and lower portions 108, 110 are made from the same material and have the same colors. In some implementations, the upper and lower portions 108, 110 are each made of a sheet of natural or synthetic textile, fabric, or other flexible material such as a woven or knit piece of cloth, or a polymeric material such as polyester or nylon. In one specific implementation, the upper and lower portions 108, 110 of the housing 100 may be made of suitable marine canvas or other textiles that are commercially available from Glen Raven Inc., such as under the brand name SUNBRELLA.

The housing 100 is formed by stitching, sewing, or otherwise bonding or coupling a left side of the upper portion 108 to a left side of the lower portion 110, a rear end of the upper portion 108 to a rear end of the lower portion 110, and a right side of the upper portion 108 to a right side of the lower portion 110. Thus, the housing 100 can form a pouch or pocket with an internal cavity configured to accommodate other components, with an opening extending left-to-right across the front end of the housing 100, the opening configured to accommodate such other components and allow a user of the housing 100 to insert such other components into the cavity through the opening or remove such other components from the cavity through the opening. In some alternative implementations, however, the upper portion 108 and lower portion 110 of the housing 100 are collectively formed from a single sheet of material that is folder over at one of the left side, rear end, or right side of the housing 100, and stitched, sewn, or otherwise bonded or coupled at the other two of the left side, rear end, and right side of the housing 100.

As further illustrated in FIG. 1, the housing 100 includes a zipper 112 coupled to the front of the upper portion 108 and to the front of the lower portion 110. In the illustrated implementation, the zipper can be moved to the right across the front of the housing 100 to open the opening at the front of the housing 100, such that the front of the upper portion 108 is only connected to the front of the lower portion 110 at the peripheral left and right sides thereof, as illustrated in FIG. 1, and can be moved to the left across the front of the housing 100 to close the opening at the front of the housing 100, such that the front of the upper portion 108 is connected to the front of the lower portion 110 along the entirety of the front of the housing 100. In other implementations, the zipper could be moved to the left across the front of the housing 100 to open the opening at the front of the housing 100, such that the front of the upper portion 108 is only connected to the front of the lower portion 110 at the peripheral left and right sides thereof, and to the right across the front of the housing 100 to close the opening at the front of the housing 100, such that the front of the upper portion 108 is connected to the front of the lower portion 110 along the entirety of the front of the housing 100. While the housing 100 illustrated herein includes the zipper 112, in alternative implementations, a similar housing may alternatively include one or more of hook and loop fasteners such as VELCRO, snaps, buttons, or other components that allow the opening at the front of the housing to be repeatedly opened and closed.

In some implementations, the upper and lower portions 108, 110 of the housing, and the seams between them and the zipper 112 are waterproof or water tight and/or airtight, such that, when the zipper 112 is closed, water and/or air cannot move from inside of the housing 100 to outside of the housing 100 or from outside of the housing 100 to inside of the housing 100. In other implementations, however, one or more of the upper and lower portions 108, 110, the seams between them, and/or the zipper 112, are not waterproof or not water tight and/or are not air tight, such that, when the zipper 112 is closed, water and/or air can move from inside of the housing 100 to outside of the housing 100 or from outside of the housing 100 to inside of the housing 100.

FIG. 2 illustrates the housing 100 with the zipper 112 in an open position and the opening at the front of the housing 100 held open so that internal components are more easily visible. In particular, FIG. 2 illustrates that the cavity formed within the housing 100 between the upper and lower portions 108, 110, is subdivided into a plurality of sub-cavities by a plurality of dividers 114. In particular, FIG. 2 illustrates that the housing 100 includes a first, left-most divider 114a, a second, central divider 114b, and a third, right-most divider 114c.

Each of the dividers 114 is made of a single sheet or piece of material that extends in a generally vertical plane across the long axis from the front of the housing 100 to the rear of the housing 100, and across the vertical axis from the upper portion 108 of the housing 100 at the top of the housing 100 to the bottom portion 110 of the housing 100 at the bottom of the housing 100. In some implementations, the dividers 114 are made from different materials than one another, and/or different materials than the upper and lower portions 108, 110. In other implementations, the dividers 114 are made from the same materials as one another, and/or the same materials as the upper and lower portions 108, 110. In some implementations, dividers 114 are each made of a sheet of natural or synthetic textile, fabric, or other flexible material such as a woven or knit piece of cloth, or a polymeric material such as polyester or nylon. In one specific implementation, the dividers 114 may be made of suitable marine canvas or other textiles that are commercially available from Glen Raven Inc., such as under the brand name SUNBRELLA.

The housing 100 is formed by stitching, sewing, or otherwise bonding or coupling upper ends of each of the dividers 114 to a lower, internal surface of the upper portion 108, and coupling lower ends of each of the dividers 114 to an upper, internal surface of the lower portion 110. Further, in some implementations, the housing 100 may be formed by stitching, sewing, or otherwise bonding or coupling rear ends of each of the dividers 114 to a front, internal surface formed where the rear end of the upper portion 108 meets and is coupled to the rear end of the lower portion 110, such as at a seam between such components. Thus, the housing 100 can include a series of relatively small individual sub-cavities or pouches or pockets within the internal cavity inside the housing 100.

In the implementation illustrated in FIG. 2, the housing 100 includes a first, left-most sub-cavity that extends up-and-down between the upper portion 108 and the lower portion 110, front-to-back between the front and rear ends of the housing 100, and left-to-right (by at least 6 inches or 7 inches, and/or less than 8 inches or 9 inches, and/or about 7.25 inches) from the left end of the housing 100 to the left-most divider 114a. The housing 100 also includes a second, left-central sub-cavity that extends up-and-down between the upper portion 108 and the lower portion 110, front-to-back between the front and rear ends of the housing 100, and left-to-right (by at least 6 inches, and/or less than 8 inches, and/or about 7 inches) from the left-most divider 114a to the central divider 114b. The housing 100 also includes a third, right-central sub-cavity that extends up-and-down between the upper portion 108 and the lower portion 110, front-to-back between the front and rear ends of the housing 100, and left-to-right (by at least 6 inches, and/or less than 8 inches, and/or about 7 inches) from the central divider 114b to the right-most divider 114c. The housing 100 also includes a fourth, right-most sub-cavity that extends up-and-down between the upper portion 108 and the lower portion 110, front-to-back between the front and rear ends of the housing 100, and left-to-right (by at least 6 inches or 7 inches, and/or less than 8 inches or 9 inches, and/or about 7.25 inches) from the right-most divider 114c to the right side of the housing 100. Each of these sub-cavities may be configured to accommodate other components of a completed floatation device.

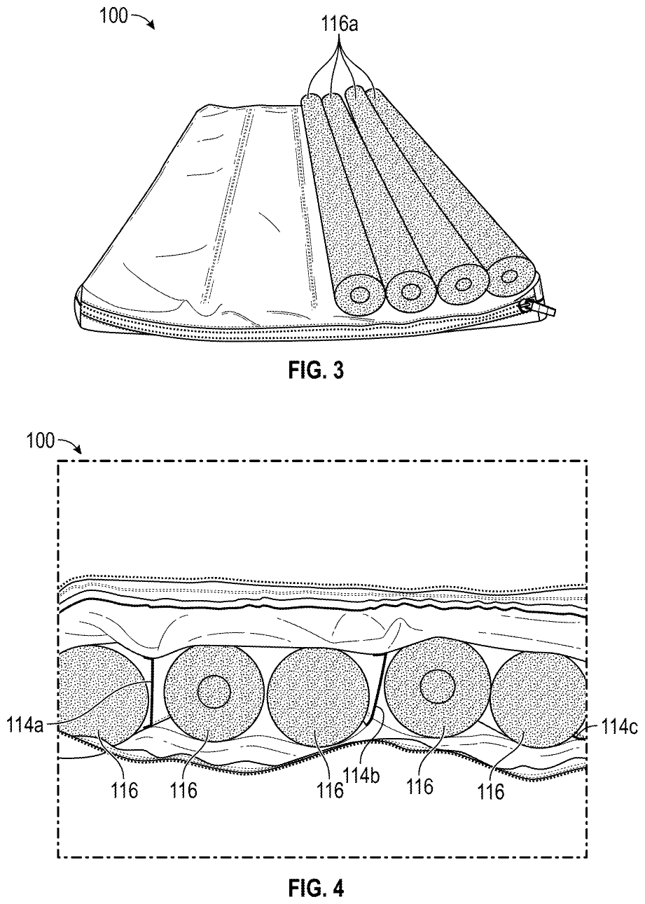

FIG. 3 illustrates a plurality of pool noodles 116 positioned on top of the housing 100. As used herein, the term “pool noodle” is used in accordance with its ordinary meaning, specifically with respect to a generally cylindrical piece of buoyant material used by people of all ages, most often in pools but also in other bodies of water, while swimming. The pool noodles 116 may have solid or hollow cylindrical bodies, may be formed of synthetic foam materials, such as polyethylene foam materials, may have lengths ranging from 48-66 inches, and may have diameters ranging from 2-4 inches, such as about three inches. The pool noodles 116 may be highly buoyant and may be inserted into the housing 100 to provide buoyancy thereto.

In some embodiments, the overall length of the housing 100 is sized to accommodate a standard length pool noodle 116. One standard pool noodle 116 size is 60¼ inches long. Accordingly, one embodiment of such a housing 100 adds an additional 2½ inches to comfortably accommodate this standard sized pool noddle, thus producing a housing 100 with an overall length of 62¾ inches. Since this embodiment is specifically sized for a standard length pool noodle 116, there is no need to cut the pool noodles to fit the housing 100.

FIG. 4 illustrates the plurality of pool noodles 116 installed within the housing 100. In particular, as illustrated in FIG. 4, each of the sub-cavities within the housing 100 can be configured, that is, sized and dimensioned, to snugly or loosely accommodate two of the pool noodles 116 adjacent or next to one another in a left-to-right direction. In particular, two pool noodles 116 can be positioned within the left-most sub-cavity, two pool noodles 116 can be positioned within the left-center sub-cavity, two pool noodles 116 can be positioned within the right-center sub-cavity, and two pool noodles 116 can be positioned within the right-most sub-cavity. Thus, eight total pool noodles 116 can be positioned within the cavity inside the housing 100 substantially adjacent or next to one another in a left-to-right direction across a width of the housing 100. Each of the pool noodles 116 held within the cavity inside the housing 100 has a front end at the front end of the housing 100, a rear end at a rear end of the housing 100, and a central longitudinal axis that extends front-to-back along the length of the housing 100 and parallel to the long axis 102. When such an assembled floatation device is in use, the dividers 114 may help to ensure that the floatation device and the housing 100 in particular maintain a generally rectangular shape, and may help to ensure that the pool noodles 116 maintain their position and alignment within the housing 100.

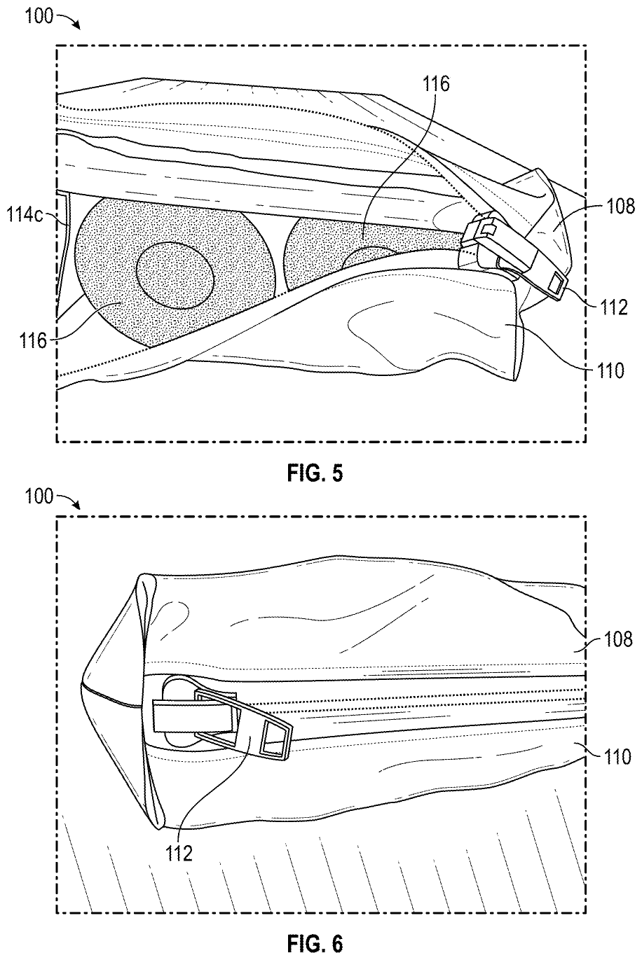

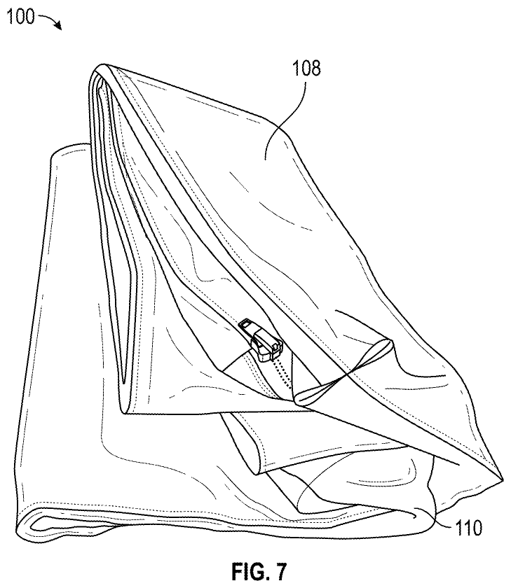

FIG. 5 illustrates a front end view of a right side of the front end of the housing 100 with the pool noodles installed and housed therein, and with the zipper 112 in the open position at the right side of the housing 100. FIG. 6 illustrates a front end view of a left side of the front end of the housing 100 with the pool noodles installed and housed therein, and with the zipper 112 in the closed position at the left side of the housing 100. FIG. 7 illustrates the housing 100 with the pool noodles 116 removed and with the housing 100 folded up, such as for storage or transportation. As illustrated in FIG. 7, the housing 100 can be stored and transported in a relatively compact form factor, which can make the storage and transportation easier. In particular, because pool noodles are relatively standard items at pools, and because they have relatively standardized dimensions, a user of the housing 100 can carry or otherwise transport the housing 100, without the pool noodles 116, with them to a pool with a relatively high degree of confidence that pool noodles will be available for use at the pool, and that such pool noodles will fit within the cavity and/or sub-cavities within the housing 100. Once at the pool, the user can install the local pool noodles into the housing 100 for use at the pool. Once done at the pool, the user can remove the local pool noodles from the housing 100 and leave them behind, taking only the housing 100 home with them.

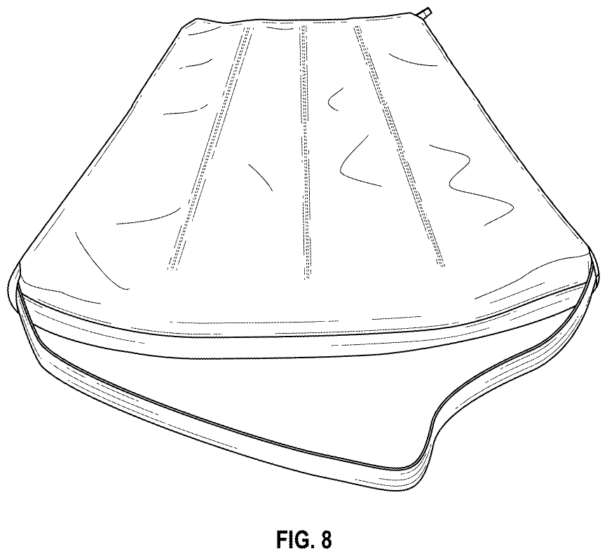

FIG. 8 illustrates a rear perspective view of a rear end of the housing 100 with an additional strap coupled to the rear end of the housing 100 opposite to the zipper 112. The strap may be employed as a handle by a user of the housing 100 when pulling the housing 100 out of a body of water, such as when the housing 100 is wet.

In some implementations, if one set of pool noodles 116 is used in the housing 100 for a sufficiently long period of time, the pool noodles 116 may deteriorate or need replacing. The housing 100 makes such replacement straightforward. In some implementations, the housing 100 is between 26 oz. and 30 oz., or is about 28 oz. when dry. In some implementations, the housing 100, or a raft or other floatation device including the housing 100, may be symmetrical top-to-bottom (i.e., about a horizontal plane parallel to the long and short axes 102, 104). In some implementations, the housing 100 is machine-washable, and can be washed in a standard washer and drier to remove pool salts, chlorine, and/or any other chemicals. In some implementations, the housing 100 can be washed in a standard washer and then air-dried. In some implementations, no component of a raft or other floatation device including the housing 100 is inflatable, such that the raft or other floatation device can be assembled and used without the time-consuming process of inflating the component(s) thereof, and such that the raft or other floatation device cannot be ruptured and rendered un-usable, such as by the paws or teeth of a dog. Such implementations result in particularly resilient and durable floatation devices.

In some implementations, no component of a raft or other floatation device including the housing 100 is water-tight or air-tight, and the housing 100 is made exclusively of non-buoyant or minimally-buoyant materials, such that the entire buoyancy or substantially the entire buoyancy of the raft or other floatation device is provided by the pool noodles 116. Such implementations result in particularly advantageous floatation devices in which the sides and ends, or peripheral edges, of the floatation device tend to sink in a body of water rather than float. Such a result is advantageous at least because it makes it easier for a person, a dog, or another animal to climb out of the body of water and onto the floatation device. In some implementations, the cavity within the housing 100 (or the sub-cavities taken together) spans the entire width and the entire length of the housing 100, such that the buoyant pool noodles 116 are collectively located across the entire width and the entire length of the housing 100. Thus, the buoyant pool noodles 116 provide a full buoyant floor that spans the full extent of the housing 100 for a person, dog, or other animal to sit or lay on when in use. Such implementations provide distinct advantages over other systems where buoyant components are provided only at the periphery of a floatation device, because they make it easier for the peripheral edges of the floatation device to be submerged in water to facilitate a human, dog, or other animal climbing onto the floatation device.

As described herein, the housing 100 includes the upper portion 108, the lower portion 110, and the dividers 114, each of which may be made of a single piece of material stitched or otherwise coupled to the other components. In some implementations, the housing 100 consists of, or includes only, such components. Thus, an assembled floatation device including the housing 100 and a plurality of pool noodles 116 may consist of, or include only, such components and the pool noodles 116. Thus, the housing 100 and a floatation device including the housing 100 may have a much simpler construction than floatation devices currently on the market.

In some implementations, a method of making the housing 100 can include stitching the dividers 114 to the upper portion 108 and to the lower portion 110. The method may also include stitching the left and right sides and the rear ends of the upper and lower portions 108, 110 to one another. The method may also include stitching the zipper 112 to the front ends of the upper and lower portions 108, 110. In some implementations, a method of assembling a floatation device may include unzipping the zipper 112 by moving the zipper 112 to its open position at the right side of the housing 100. The method may further include positioning two of the pool noodles 116 within each of the four sub-cavities inside of the housing 100. The method may further include zipping the zipper 112 by moving the zipper 112 to its closed position at the left side of the housing 100. Once a floatation device has been assembled in this manner, the pool noodles 116 are completely enclosed within the housing 100, such that the housing 100 protects the pool noodles 116 from damage, such as from a dog's paws and/or teeth. In some implementations, a method of disassembling a floatation device may include unzipping the zipper 112 by moving the zipper 112 to its open position at the right side of the housing 100. The method may further include removing the pool noodles 116 from each of the four sub-cavities inside of the housing 100. The method may further include zipping the zipper 112 by moving the zipper 112 to its closed position at the left side of the housing 100.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A housing for use in a floatation device, the housing having substantially no buoyancy in water, the housing comprising:
a rectangular upper portion having a first side, a second side, a third side, and a fourth side;
a rectangular lower portion having a first side, a second side, a third side, and a fourth side, wherein the first side of the rectangular lower portion is coupled to the first side of the rectangular upper portion, the second side of the rectangular lower portion is coupled to the second side of the rectangular upper portion, and the third side of the rectangular lower portion is coupled to the third side of the rectangular upper portion; and
a fastener configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion;
wherein the internal cavity is configured to be filled with pool noodles such that the pool noodles collectively extend across substantially an entire length of the housing and across substantially an entire width of the housing.

2. The housing of claim 1 wherein the internal cavity is configured to be filled with pool noodles such that the pool noodles collectively extend across an entire length of the housing and across an entire width of the housing.

3. The housing of claim 1 wherein the rectangular upper portion is made of a single sheet of fabric.

4. The housing of claim 3 wherein the rectangular lower portion is made of a single sheet of fabric.

5. The housing of claim 1, further comprising a first divider coupled to an internal surface of the rectangular upper portion and coupled to an internal surface of the rectangular lower portion such that the first divider has a first end proximate the fourth side of the rectangular upper portion and proximate the fourth side of the rectangular lower portion.

6. The housing of claim 5, further comprising a second divider coupled to an internal surface of the rectangular upper portion and coupled to an internal surface of the rectangular lower portion such that the second divider has a first end proximate the fourth side of the rectangular upper portion and proximate the fourth side of the rectangular lower portion.

7. The housing of claim 6 wherein the second divider is parallel to the first divider.

8. The housing of claim 7, further comprising a third divider coupled to an internal surface of the rectangular upper portion and coupled to an internal surface of the rectangular lower portion such that the third divider has a first end proximate the fourth side of the rectangular upper portion and proximate the fourth side of the rectangular lower portion.

9. The housing of claim 8 wherein the third divider is parallel to the first and second dividers.

10. The housing of claim 1 wherein the housing is configured to be folded up into a compact configuration for storage and transport.

11. A flotation device, comprising:
a housing including:
a rectangular upper portion having a first side, a second side, a third side, and a fourth side;
a rectangular lower portion having a first side, a second side, a third side, and a fourth side, wherein the first side of the rectangular lower portion is coupled to the first side of the rectangular upper portion, the second side of the rectangular lower portion is coupled to the second side of the rectangular upper portion, and the third side of the rectangular lower portion is coupled to the third side of the rectangular upper portion; and
a fastener configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion;
wherein the internal cavity is configured to be filled with pool noodles such that the pool noodles collectively extend across substantially an entire length of the housing and across substantially an entire width of the housing; and
a plurality of pool noodles located inside the internal cavity, wherein the pool noodles collectively extend across substantially an entire length of the housing and across substantially an entire width of the housing.

12. The floatation device of claim 11 wherein the pool noodles collectively extend across an entire length of the housing and across an entire width of the housing.

13. The floatation device of claim 11, further comprising a first divider coupled to an internal surface of the rectangular upper portion and coupled to an internal surface of the rectangular lower portion such that the first divider has a first end proximate the fourth side of the rectangular upper portion and proximate the fourth side of the rectangular lower portion, wherein two pool noodles of the plurality of pool noodles are located between the first divider and the first sides of the rectangular upper and lower portions.

14. The floatation device of claim 13, further comprising a second divider coupled to an internal surface of the rectangular upper portion and coupled to an internal surface of the rectangular lower portion such that the second divider has a first end proximate the fourth side of the rectangular upper portion and proximate the fourth side of the rectangular lower portion, wherein two pool noodles of the plurality of pool noodles are located between the first divider and the second divider.

15. The floatation device of claim 14, further comprising a third divider coupled to an internal surface of the rectangular upper portion and coupled to an internal surface of the rectangular lower portion such that the third divider has a first end proximate the fourth side of the rectangular upper portion and proximate the fourth side of the rectangular lower portion, wherein two pool noodles of the plurality of pool noodles are located between the second divider and the third divider and two pool noodles of the plurality of pool noodles are located between the third divider and the third sides of the rectangular upper and lower portions.

16. A method of manufacturing a housing for use in a floatation device, comprising:
obtaining a first rectangular sheet of material having a first side, a second side, a third side, and a fourth side;
obtaining a second rectangular sheet of material having a first side, a second side, a third side, and a fourth side;
stitching the first side of the rectangular lower portion to the first side of the rectangular upper portion, the second side of the rectangular lower portion to the second side of the rectangular upper portion, and the third side of the rectangular lower portion to the third side of the rectangular upper portion; and
stitching a zipper to the fourth side of the rectangular upper portion and to the fourth side of the rectangular lower portion such that the zipper is configured to be moved in a first direction along the fourth side of the rectangular upper portion and the fourth side of the rectangular lower portion to open the housing and to be moved in a second direction along the fourth side of the rectangular upper portion and the fourth side of the rectangular lower portion to close the housing such that the housing completely encloses an internal cavity that extends to the first side of the rectangular upper portion, to the first side of the rectangular lower portion, to the second side of the rectangular upper portion, to the second side of the rectangular lower portion, to the third side of the rectangular upper portion, to the third side of the rectangular lower portion, to the fourth side of the rectangular upper portion, and to the fourth side of the rectangular lower portion;
wherein the internal cavity is configured to be filled with pool noodles such that the pool noodles collectively extend across substantially an entire length of the housing and across substantially an entire width of the housing.

17. The method of claim 16, further comprising:
stitching a first divider to an internal surface of the rectangular upper portion and to an internal surface of the rectangular lower portion such that the first divider has a first end proximate the fourth side of the rectangular upper portion and proximate the fourth side of the rectangular lower portion.

18. The method of claim 17, further comprising:
stitching a second divider to an internal surface of the rectangular upper portion and to an internal surface of the rectangular lower portion such that the second divider has a first end proximate the fourth side of the rectangular upper portion and proximate the fourth side of the rectangular lower portion.

19. The method of claim 18, further comprising:
stitching a third divider to an internal surface of the rectangular upper portion and to an internal surface of the rectangular lower portion such that the third divider has a first end proximate the fourth side of the rectangular upper portion and proximate the fourth side of the rectangular lower portion.

20. The method of claim 19 wherein the first, second, and third dividers are parallel to one another along their entire lengths.
